(19) United States
(12) Patent Application Publication
(10) Pub. No.: US 2003/0061267 A1
(43) Pub. Date: Mar. 27, 2003

(54) Method and apparatus to remotely obtain device characteristics for simple devices

(76) Inventor: Robert A. Dunstan, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,944

(22) Filed: Sep. 27, 2001

(51) Int. Cl. G06F 15/16

(52) U.S. Cl. 709/201

(57) ABSTRACT

An electronic device is presented that is capable of being connected to a bus. The electronic device has a memory device. The memory device contains a remote location's destination information. Control or characteristic information for the electronic device is stored at the remote location. Also presented is a system. In the system, many electronic devices are each connected to a memory device. Each memory device contains a remote location's destination information. Control or characteristic information for the electronic device is stored at the remote location. Many device specific buses are connected to the many electronic devices. Many device specific network bridge devices are connected to the many device specific buses and a home network. Also, a device for communicating with a remote network is included.

### BACKGROUND OF THE INVENTION

1. Field of the Invention

This invention relates to simple electronic devices, and more particularly to a method and apparatus for providing device characteristics remotely.

2. Description of the Related Art

For many simple electronic devices, such as consumer electronic (CE) products, various types of methods are used to identify a specific CE device, determine if a new device is added to a system and to associate specific device code characteristics in order to control the devices that exist on a system. These methods are known as “plug and play.” Various plug and play methods exist for various buses, such as universal serial bus (USB), peripheral component interconnect (PCI), etc. Most of these methods have drawbacks, such as being overly complex, too expensive, requiring too much power, or that the devices do not contain sufficient device descriptions to allow unattended and user independent operation (e.g., no device drivers on an accessible medium, such as a hard disc drive, floppy disc, or compact disc read-only memory (CD-ROM)).

One example of determining device characteristics in commanding and controlling a device is the universal plug-n-play (UPnP) protocol. Some UPnP requirements are that: every client device supports a transmission control protocol/Internet protocol (TCP/IP) stack; a dynamic host configuration protocol (DHCP) client; and an Internet web server. UPnP is a very complete and complex solution that allows a wide range of devices to be uniquely addressed and provides a standard mechanism to get class-specific command and control information. UPnP, however, is relatively costly. For example, for hardware to support UPNP, it may be necessary to have a microcontroller with 64K random access memory (RAM), 128K of flash memory, and additional hardware/software to support an Ethernet connection. For complex devices that may already be Internet enabled, the incremental cost is relatively low. For most simple devices that are less complex, however, the incremental cost burden to add a plug and play (e.g., UpnP) level of functionality is not feasible.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates an embodiment of the invention including a home network.

FIG. 2A illustrates a typical simple consumer electronic (CE) device.

FIG. 2B illustrates a typical simple CE device.

FIG. 3A illustrates one embodiment of the invention having identification (ID) information embedded in simple device.

FIG. 3B illustrates one embodiment of the invention having ID information embedded within simple device.

FIG. 4 illustrates a simple CE device.

FIG. 5 illustrates a block diagram of an embodiment of the invention.

### DETAILED DESCRIPTION OF THE INVENTION

The invention generally relates to a method and apparatus for remotely obtaining simple device characteristics. Referring to the figures, exemplary embodiments of the invention will now be described. The exemplary embodiments are provided to illustrate the invention and should not be construed as limiting the scope of the invention.

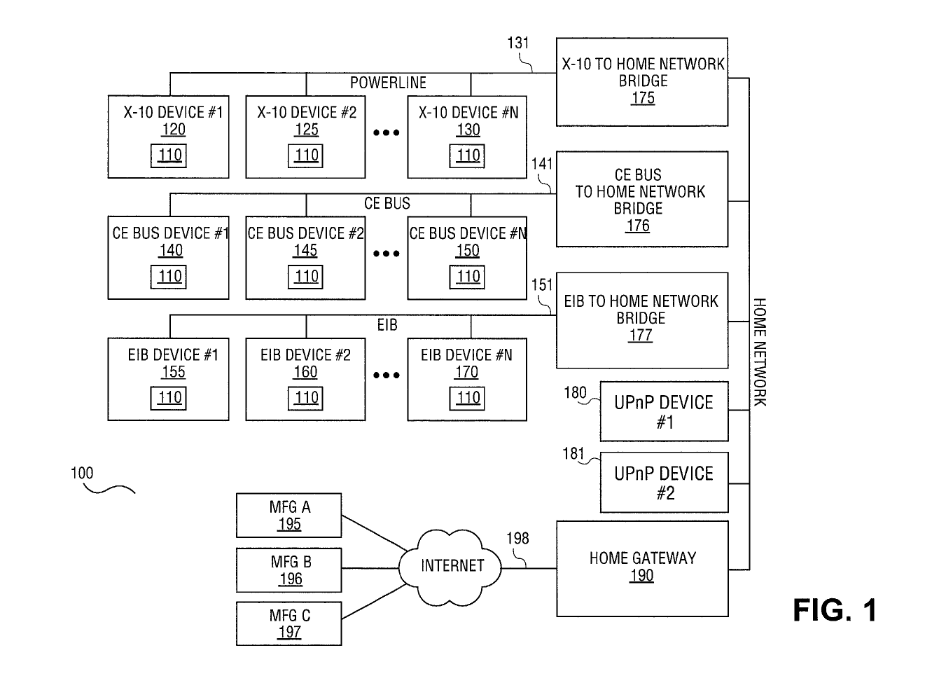

FIG. 1 illustrates a home network system 100 including an embodiment of the invention. System 100 comprises X-10 (X-10, Inc.) devices 120, 125 and 130, X-10 to home network bridge 175, power line 131, consumer electronics bus (CE Bus) device 140, 145, and 150, CE Bus 141, CE Bus to home network bridge 176, European installation bus (EIB) device 155, 160, and 170, EIB 151, EIB to home network bridge 177, Universal plug-n-play (UPnP) device 180 and 181, home network, 161, home gateway 190, bus 198, manufacturer A web-site 195, manufacturer B web-site, 196, and manufacturer C web-site 197. It should be noted that other CE device technologies, busses, manufacturers, etc. may be added to system 100 without diverging from the scope of the invention.

In one embodiment of the invention, X-10 devices 120, 125, 130, CE Bus device 140, 145, 150, and EIB devices 155, 160 and 170 have identification (ID) information 110 embedded in the device. In one embodiment of the invention, ID information 110 contains a uniform resource locator (URL) to a specific page on an Internet web-site. In one embodiment of the invention, ID information 110 contains an Internet protocol (IP) address to an Internet web-site. ID information 110 can be imbedded in a simple device with any known means, such as nonvolatile memory, electrically erasable programmable read-only memory (EEPROM), flash memory, etc.

In one embodiment of the invention, when a device in system 100 is polled (by a central processor, not shown; or an intelligent bridge), the device in turn will respond with the information contained in ID information 110. It should be noted that X-10 devices, CE Bus devices, and EIB devices that exist do not contain ID information 110. When a home network device contained in system 100 responds with ID information 110, system 100 determines whether device control information/characteristics are already stored/known to system 100. System 100 will then either control the device if the information already exists in system 100, or system 100 will retrieve information from a manufacture web-site depending upon ID information 110.

In one embodiment of the invention, a device's firmware may be updated through the Internet to change device characteristics. In this manner, whenever a manufacturer upgrades a device's firmware, or adds new device information, a home network system, such as system 100, may obtain the device's updated control/characteristic information. In one embodiment of the invention, each home network device contains an ID for the specific device. This can be a simple code, such as binary information, or extensive mark-up language (XML) information regarding the specific device. Therefore, in this embodiment of the invention, once the manufacturing Internet web-site is accessed, specific information for the specific device is in turn retrieved and forwarded to system 100.

In one embodiment of the invention, by having ID information 110 embedded within a home network device, system 100 can achieve plug-n-play like operability for simple devices typically not using a plug and play (e.g., UpnP) protocol. Moreover, less hardware and memory are needed by devices to support system 100 operability.

In one embodiment of the invention, the home network devices (X-10, CE Bus, EIB, etc.) broadcast ID information 110 without being polled by a host. As a home network device broadcasts its ID information 110, a host residing on the network determines whether control/characteristic information exists for the specific home network device. If so, system 100 need not retrieve information from the Internet/Intranet. If, however, a host residing on system 100 determines that it does not have the characteristic/control information for the home network device, system 100 would then retrieve the home network device's information over the Internet/Intranet and return it to the host.

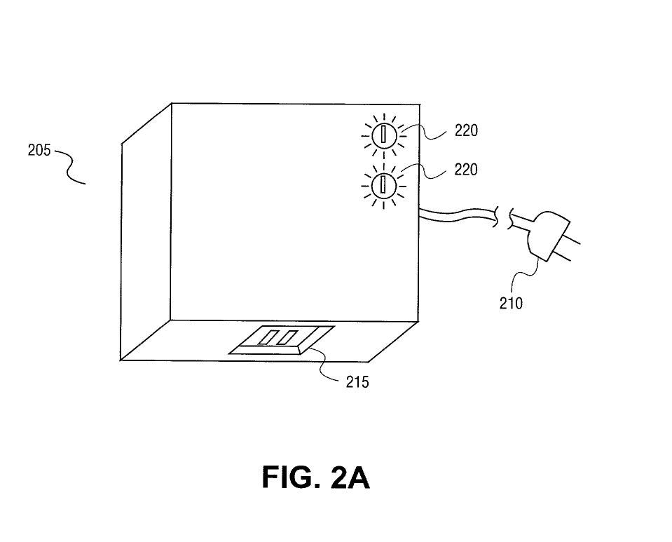

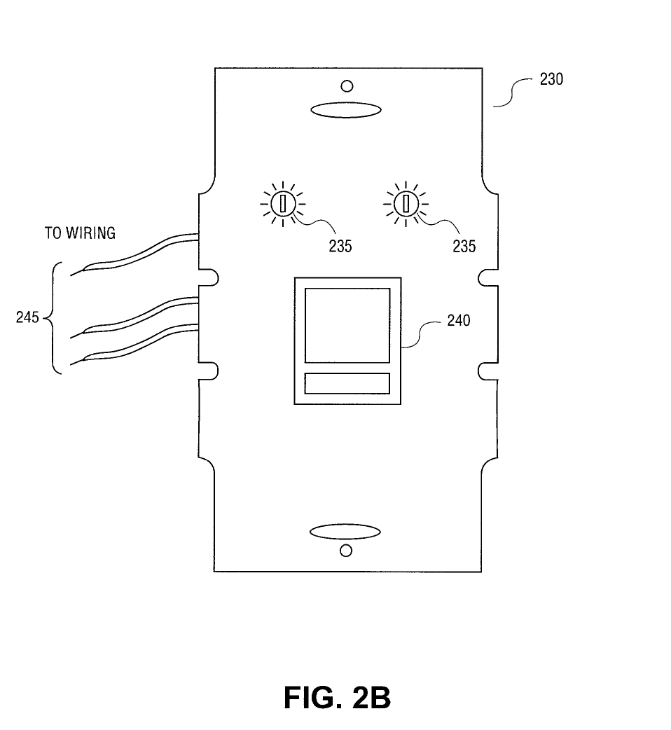

FIG. 2A illustrates simple device 205, which, for example purposes, is an X-10 appliance switch. Simple device 205 includes outlet plug 210, input plug 215, and control selectors 220. Simple device 205 is known as a “dumb” device. Simple device 205 does not contain a micro controller, or other control mechanisms that can enable simple device 205 to act as a plug and play (e.g., UpnP) device.

FIG. 2B illustrates another example of a simple device 230. Simple device 230, for example, is an X-10 wall switch. Simple device 230 comprises wires 245 to connect to a home power line, control selectors 235 and switch 240. Simple device 230, does not contain a micro-controller, or other mechanisms to accomplish plug and play (e.g., UpnP) operability.

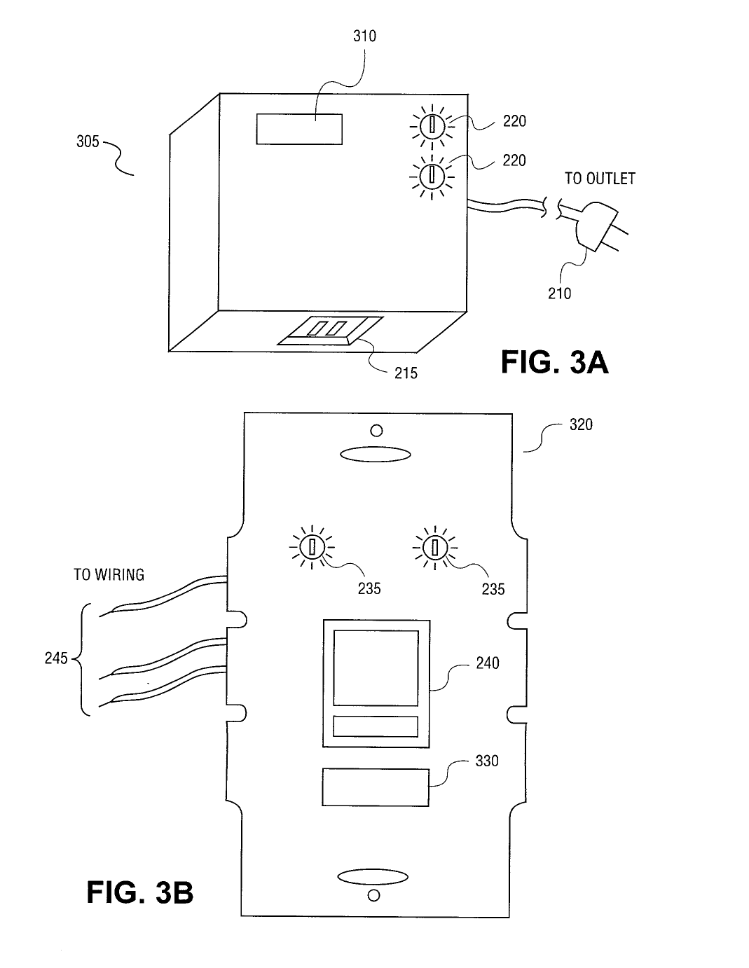

FIG. 3A illustrates an embodiment of the invention having ID information 310 embedded in simple device 305. In one embodiment of the invention, ID information 310 responds to polling by a host on a home network system, such as system 100 illustrated in FIG. 1, by returning a simple identifier, such as a URL. In another embodiment, simple device 305 broadcasts the embedded information contained in ID information 310. ID information 310 can be embedded in a simple device with any known means, such as non-volatile memory, electrically erasable programmable read-only memory (EEPROM), flash memory, various ROM technology, etc.

FIG. 3B illustrates an embodiment of the invention having ID information 330 embedded within simple device 320. ID information 330 contains a simple identifier, such as a URL. In one embodiment of the invention, simple device 320 responds to polling by a host device on a home network system, such as system 100 illustrated in FIG. 1, and returns the embedded information contained in ID information 330. In another embodiment of the invention, simple device 320 broadcasts the embedded information contained in ID information 330 to a host located on the home network. ID information 330 can be imbedded in a simple device with any known means, such as non-volatile memory, EEPROM, flash memory, various ROM technology, etc.

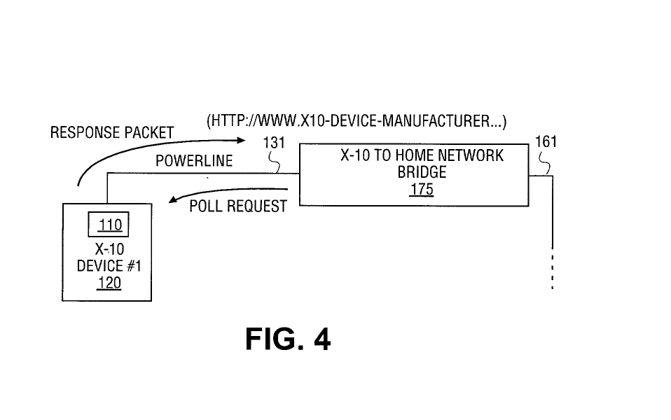

FIG. 4 illustrates a simple CE device, in this example X-10 device 120, that either responds to a pointed request or broadcasts ID information 110 on its bus (power line 131). ID information 110 travels through the power line 131, through X-10 to home network bridge 175, and on to the home network 161. In this example, ID information 110 contains URL information http:/www.x10-device-manufacturer . . . . In this example, ID information 110 contains the type of protocol, hyper-text transfer protocol (http) and the IP address or domain name of the web page that should be fetched using the http protocol (in this example, http:/www.x10-device-manufacturer . . . ).

In one embodiment of the invention, ID information 110 also contains a specific device ID, such as a simple identifier (e.g., “5”). This simple identifier contained in ID information 110, allows a host to contact the URL and retrieve specific control/characteristic information for a specific device (e.g., device or device type “5”). One should note that the simple identifier can be any scheme for identifying a particular device or device type.

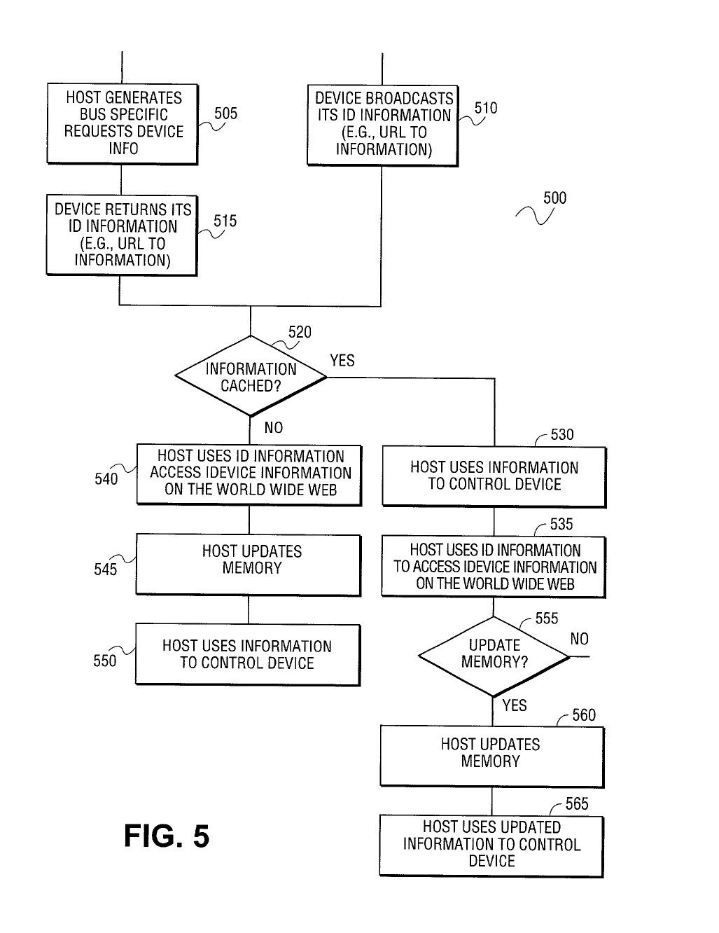

FIG. 5 illustrates a block diagram of an embodiment of the invention. In one embodiment of the invention, process 500 begins with either block 505, block 510 or both blocks 505 and 510 simultaneously. Process 500 branches to block 505 for passive CE devices, and block 510 is for active CE devices. By passive, it is meant that the CE device does not broadcast ID information on its bus. By active, it is meant the CE device does broadcast its ID information on its bus. In the case of block 505, a host on a home network system (e.g., system 100 illustrated in FIG. 1) generates bus specific requests for device information.

In one embodiment of the invention, the bus specific requests go out to all devices coupled to the device specific bus. One should note that the bus specific requests can be programmed to occur during any periodicity, such as once every 10 seconds, one per minute, etc. After block 505 is completed, process 500 then continues with block 515. In block 515, the devices on the device specific bus return ID information to the host that generated the request. Once block 515 completes, process 500 continues with block 520.

In the case of process 500 beginning with block 510, a device on the home network system broadcasts its ID information on its specific bus. Block 500 would then continue with block 520. Block 520 determines whether the ID information that is either returned through block 515 or broadcast through block 510 is already in a host's memory. If block 520 determines that the ID information is already in memory (e.g., cache memory), block 500 continues with block 530. In block 530, the host can use the ID information already in memory to control the specific device. Process 500 then continues with block 535, which uses the ID information (e.g., URL) to access device information on the Internet/Intranet. Process 500 then continues with block 555.

Block 555 determines whether the information already stored in the host memory needs to be updated by comparing with the retrieved information from the Internet/Intranet. If block 555 determines that the information already stored in memory does not need to be updated (i.e., the retrieved information matches the information stored in memory), process 500 is complete. If block 555 determines that the information stored in memory does need to be updated with the information retrieved from the Internet/Intranet, process 500 continues with block 560. Block 560 updates the host's memory (including temporary memory, e.g., cache memory) with the information retrieved from the Internet/Intranet. In block 565, the host uses the updated information to control the specific device. One should note that if communication with the Internet/Intranet is lost or the system is not connected, the information already stored in memory (and temporary memory, e.g., cache memory) is used until the system is connected or communication is regained.

If block 520 determines that the ID information is not already stored in memory on the host, process 500 continues with block 540. In block 540, the host uses the ID information (e.g., URL and/or simple identifier) to access the specific device's information/characteristics on the Internet/Intranet. Process 500 continues with block 545, which updates the host's memory (and temporary memory, e.g., cache memory) with the retrieved device's characteristics/control information. In block 550, the host uses the retrieved information to control the specific device. One should note that if the system is not connected to the Internet/Intranet, the system will retry at a later time when the system is connected to the Internet/intranet or communication is regained. One should note that many scheduling algorithms can be implemented for determining when to update a device's characteristic/control information without diverging from the scope of the embodiments.

With process 500, it can readily be seen that a simple device that is either polled by a host on a home network system, or one that broadcasts ID information on its specific bus can act like a plug and play (e.g., UpnP) device. This functionality is obtained without the consumer expense, complexity, necessitated power requirements or chip real estate. Some devices that already have a microprocessor incorporated, can easily be modified to include the embedded ID information for a relatively small cost. For most other classes of devices with a lower level of complexity, however, adding the functionality of plug and play (e.g., UpnP) may be cost prohibitive. Moreover, a service type party can monitor and update a users control/characteristic data when necessary.

Therefore, with the above embodiments of the invention, a home network system can easily discover these less complex devices, and still have the capability to get complete information. Moreover, embodiments of the invention allow simple devices to be updated by the manufacturer.

Moreover, by adding ID information to a simple device, embodiments of the invention remove the complexity of complete device control/characteristic information to a centralized location. By using the Internet/Intranet for distributed repository of device specific information, the information can readily be accessed with the simple ID information. In one embodiment of the invention, upon a manufacturer correcting a “bug” or updating a device's description, a home network system (e.g., system 100 as illustrated in FIG. 1) can retrieve the information, or correct the “bug” upon the device being connected to the home network. For devices having firmware, various modifications, or license updates, can easily be retrieved/updated through embodiments of the invention.

For the above-identified embodiments, if the host already has the device characteristics/control information stored, there is no need to connect to the Internet/Intranet to retrieve device characteristic/control information. Once the home network is connected to the Internet/Intranet, one embodiment of the invention silently retrieves the device's characteristic/control information and compares it with the information already stored by the host. For the case where a device is connected to a specific bus, and the host does not have control/characteristic information for the device, a user can be prompted/notified that the home network needs to be connected to the Internet/Intranet for the host to retrieve the newly connected device's characteristic/control information. In one embodiment of the invention, the system will automatically connect to the Internet/Intranet to retrieve device characteristic/control information. One should note that many configurations can be selected by a user, such as prompt before connecting to the Internet/Intranet, prompt before disconnecting from the Internet/Intranet, etc.

In one embodiment of the invention, a central host processor including a monitor (not shown) is coupled with home network 161. In this embodiment of the invention, as a device is connected to a bus in the system (e.g., system 100 illustrated in FIG. 1) a notification on the monitor informs a user whether the home network needs to connect to the Internet/Intranet to retrieve the connected device's control/characteristic information, whether the newer connected device's control/characteristic information is already stored on the host, when device information is updated, and when there is a problem with the site where the information to be retrieved is stored. In one embodiment of the invention, the notification can be turned off. One should note that many types of means for notification can be implemented without diverging from the scope of the invention, such as menus, sound, icons, etc. In one embodiment of the invention, a log is kept so that a user of the system can check when files were updated/checked for the latest information for the specific device. In one embodiment of the invention, a manufacturer or third party can check when files were updated/checked for the latest information for the specific device.

The above embodiments can also be stored on a device or medium and read by a machine to perform instructions. The device or medium may include a solid-state memory device and/or a rotating magnetic or optical disk. The device or medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
an electronic device capable of being coupled to a bus, the electronic device having a memory device, the memory device contains a remote location's destination information, wherein one of control and characteristic information for the electronic device is stored at the remote location.

2. The apparatus of claim 1, wherein the remote location's destination information is one of a uniform resource locator (URL) and an Internet protocol (IP) address.

3. The apparatus of claim 2, wherein the electronic device's characteristics and control information is maintained at the remote location.

4. The apparatus of claim 1, wherein the electronic device is a consumer electronic (CE) device.

5. The apparatus of claim 1, wherein the electronic device transmits the remote location's destination information on a device specific bus when coupled to the device specific bus.

6. A system comprising:
a plurality of electronic devices each coupled to a memory device, each of the memory devices contain a remote location's destination information, wherein one of control and characteristic information for the electronic device is stored at the remote location;
a plurality of device specific buses coupled to the plurality of electronic devices;
a plurality of device specific network bridge devices coupled to the plurality of device specific buses and a home network; and
a device for communicating with a remote network.

7. The system of claim 6, further comprising:
a central processing device coupled to the home network;
a central memory device coupled to the central processing device; and
a display coupled to the central processing device.

8. The system of claim 6, wherein the remote location's destination information is one of a uniform resource locator (URL) and an Internet protocol (IP) address.

9. The system of claim 8, wherein each of the plurality of electronic device's characteristics and control information is maintained at a specific remote location.

10. The system of claim 6, wherein the electronic device is a consumer electronic (CE) device.

11. The system of claim 6, wherein the remote network is one of the Internet and an Intranet.

12. The system of claim 11, wherein each of the device's characteristics and control information is retrieved from a specific remote location upon coupling of the device to its device specific bus.

13. A method comprising:
generating a request for a device's identification information;
receiving the requested device's identification information;
determining whether characteristic information for the device is previously stored on a system;
communicating with a remote location if the device's characteristic information is not previously stored on the system;
retrieving the device's characteristic information if the characteristic information is not previously stored on the system;
storing the characteristic information not previously stored on the system.

14. The method of claim 13, further comprising:
using the device's characteristic information to control the device;
determining whether the stored characteristic information needs to be updated; and
replacing the stored characteristic information with new characteristic information if the stored characteristic information needs to be updated.

15. The method of claim 13, wherein the device's identification information is a remote location's destination information.

16. The method of claim 15, wherein the remote location's destination information is one of a uniform resource locator (URL) and an Internet protocol (IP) address.

17. The method of claim 13, further comprising:
displaying information on a display device.

18. An apparatus comprising a machine-readable medium containing instructions which, when executed by a machine, cause the machine to perform operations comprising:
generating a request for a device's identification information;
receiving the requested device's identification information;
determining whether characteristic information for the device is previously stored on a system;
communicating with a remote location if the device's characteristic information is not previously stored on the system;
retrieving the device's characteristic information if the characteristic information is not previously stored on the system;
storing the characteristic information not previously stored on the system.

19. The apparatus of claim 18, further containing instructions which, when executed by a machine, cause the machine to perform operations including:
using the device's characteristic information to control the device;
determining whether the stored characteristic information needs to be updated; and
replacing the stored characteristic information with new characteristic information if the stored characteristic information needs to be updated.

20. The apparatus of claim 18, wherein the device's identification information is a remote location's destination information.

21. The apparatus of claim 20, wherein the remote location's destination information is one of a uniform resource locator (URL) and an Internet protocol (IP) address.

22. The apparatus of claim 18, further containing instructions which, when executed by a machine, cause the machine to perform operations including:
displaying information to a display device.
